(19) United States
(12) Patent Application Publication
(10) Pub. No.: US 2010/0143689 A1
(43) Pub. Date: Jun. 10, 2010

(54) Method For Manufacturing A Decorative Panel And A Decorative Panel

(76) Inventors: Wilhelmus Josephus Alex Van De Wall, Heeze (NL); Irma Vogels-Jansen, Budel (NZ)

Correspondence Address: ROBERTS & ROBERTS, LLP;ATTORNEYS AT LAW, P.O. BOX 484, PRINCETON, NJ, 08542-0484, US

(21) Appl. No.: 12/602,280

(22) PCT Filed: May 30, 2008
(86) PCT No.: PCT/NL08/00142

§ 371 Date: Jan. 4, 2010

(30) Foreign Application Priority Data
Jun. 1, 2007 (NL) 1033924

(51) Int. Cl. B32B 21/10; B44C 5/04

(52) U.S. Cl. 428/292.4; 156/273.7

(57) ABSTRACT

The present invention relates to a method for manufacturing a decorative panel, in which a core and a decorative layer, which decorative layer comprises radiation-curable components, are placed in a press and are pressed together therein under elevated temperature and pressure conditions. The present invention further relates to a decorative panel comprising a core provided with a decorative layer, which decorative layer comprises a radiation-curable component.

The present invention relates to a method for manufacturing a decorative panel, in which a core and a decorative layer, which decorative layer comprises radiation-curable components, are placed in a press and are pressed together therein under elevated temperature and pressure conditions. The present invention further relates to a decorative panel comprising a core provided with a decorative layer, which decorative layer comprises a radiation-curable component, as well as to the use of such a panel.

From German Offenlegungsschrift DE 34 18 282 there is known a method for manufacturing a decorative panel, wherein a decorative layer is applied to an underlay, which decorative layer comprises a mixture of radiation-polymerisable components, after which the decorative layer is irradiated and pressed together with the underlay to obtain a scratch resistance of at least about 1.5 Newton.

From International application WO 00/22039 there is known a method for manufacturing a laminate, in which a planar substrate is provided with a coating based on acrylate polymers, to which coating SiO₂ nanoparticles have been added to give the laminate material a scratch resistance of at least 3.5 Newton. Such materials are in particular used for floors, in which application scratch resistance is an important parameter.

From U.S. Pat. No. 4,789,604 in the name of the present applicant there is known a method for manufacturing a decorative panel, in which a liquid synthetic resin layer is a applied to a substrate layer, after which a film having a surface roughness is applied to the resin layer, said surface roughness being transferred to the resin layer, after which the resin layer is polymerised by exposure to radiation. Subsequently, the resin layer and the substrate are pressed together under elevated temperature conditions.

From European patent application No. 0 338 221 there is known a radiation-curable coating, to which coating, which is based on an acrylate mixture, matting agents are added in an amount of 20-60 weight percentage. Setting the matting degree by means of matting agents has appeared to be difficult in practice, because the matting agents adversely affect the crosslinking reaction of the matrix material, whilst in addition the use of matting agents has an adverse effect on the scratch resistance of a coating thus obtained.

From European patent application No. 0 706 834 there is known a method for producing a substrate material provided with a UV curable lacquer consisting of a lacquer based on an acrylate mixture, a UV initiator and other usual additives. The matting degree of the aforesaid UV lacquer is adjusted by the addition of mono- and/or di-functional monomers, and UV hardening is effected with several radiation sources with a defined range of wavelengths. Thus a first UV source is used which emits monochromatic UV in the range 100-200 nm, whereupon the coating thus applied to the substrate layer is subjected to a second radiation stage, using UV radiation having a higher a wavelength.

From German Offenlegungsschrift DE 198 42 510 there is known a method for structuring the surface of a UV curable lacquer, using UV radiation having a wavelength of maximally 250 nm. Subsequently, a postcuring treatment with long-wave UV or EB (electron beam) radiation must take place. An example of a UV curable lacquer mentioned therein is a mixture of monomers and prepolymers of acrylate components, using paper or a plastic in a thickness of 80-500 μm as the substrate material.

The traditional process of manufacturing HPL (high-pressure laminates) and HPL compact plates is carried out in a press under elevated temperature and pressure conditions. The melamine resin that is used will melt under said elevated temperature conditions in the press member and subsequently liquefy, with the surface of the melamine resin more or less taking on the microstructure of the press. The thus structured melamine resin will form a highly crosslinked network as a result of the elevated temperature conditions and form a scratch-resistant and hard coating after being removed from the press.

The present inventors have found that obtaining a microstructure in radiation-curable surfaces is possible only to a limited degree, because the degree of gloss will increase again after some time, which effect occurs in particular in the case of exterior use. The present inventors attribute such a change in the degree of gloss to the stress relaxation in the thermosetting coating.

The object of the present invention is thus to provide a method for manufacturing a decorative panel, in which a decorative layer comprising radiation-curable components is used, which decorative layer can be given a structure that will be retained for a prolonged period of time.

Another object of the present invention is to provide a method for manufacturing a decorative panel, in which the decorative layer comprises radiation-curable components, which decorative layer can be given a structure which will remain stable for a prolonged period of time even after being exposed to moisture and temperature and environmental influences, and which will not lead to visually unacceptable changes in gloss.

The method as referred to in the introduction is characterised in that before the pressing operation, the decorative layer is subjected to a radiation treatment comprising a first radiation stage, using a wavelength in the 100-250 nm range, and a second radiation stage, using long-wave UV and/or electron beam (EB) radiation, so as to minimise the change in the degree of gloss in the thus cured decorative layer.

The present inventors have surprisingly found that the degree of gloss thus obtained is retained for a prolonged period of time when the aforesaid radiation treatment is carried out first and subsequently the pressing operation. After the decorative layer has been subjected to a radiation treatment, using a wavelength in the 100-250 nm range, it is preferable to carry out a post-curing step, using long-wave UV radiation, viz. a wavelength in the 200-400 nm range, or EB (electron beam) radiation. The present inventors assume that the decorative layer will exhibit a slightly matted surface as a result of the aforesaid radiation treatment comprising two radiation stages, after which the surface will plasticize or deform during the pressing operation under elevated temperature conditions and there will no longer be any stress relaxation after the pressing operation, so that the thus obtained degree of gloss will be practically stable from the viewpoint of time. The structured surface of the press member will thus be incorporated in the decorative layer practically in a substantially stress-free and reversible manner. Preferably, the decorative layer does not comprise any solid particles, the decorative layer in particular comprises maximally 5%, more in particular maximally 1% solid particles, notably amorphous SiO₂ nanoparticles, based on the weight of the cured decorative layer.

Suitable radiation-curable components include (meth)acrylate compounds, for example epoxy(meth)acrylate, silicone(meth)acrylate, polyester(meth)acrylate en urethane(meth)acrylate. The decorative layer may also comprise mono(meth)acrylate, di(meth)acrylate, tri(meth)acrylate, tetra(meth)acrylate, penta(meth)acrylate and hexa(meth)acrylate. The core layer is in principle not critical and may comprise a material selected from the group consisting of wood, a number of paper layers, plastics, metals, nonwovens and fibre mats, which may or may not be impregnated with a resin.

In a special embodiment of the present invention, the decorative layer comprises an underlayer, which underlayer comprises paper, and which underlayer is present on a core layer comprising a stack of fibre-containing layers, wherein the underlayer and the decorative layer present thereon is supported on the fibre-containing layers during the pressing operation, such that the radiation-cured decorative layer forms the outermost layer of the decorative panel. The paper used for the underlayer may contain partially cured thermosetting synthetic resins.

The stack of fibre-containing layers is preferably selected from the group consisting of sodium kraft paper, a bound fabric and a densified fibre mat, which bound fabric is preferably selected from the group consisting of wood and cellulose fibres, wherein the pressing operation is carried out at a temperature of about 80-220° C., in particular 120-220 gc, and a pressure of about 5-100 bar, in particular 10-100 bar.

The first radiation treatment of the decorative layer, during which matting takes place, is carried out at a wavelength in the 100-250 nm range, preferably in the 170-230 nm range, in particular 170-180 nm, in particular using a radiation source which emits monochromatic radiation having a wavelength of 172 nm. In specific embodiments it is preferable to use a radiation source which emits monochromatic radiation having a wavelength of 222 nm. The total radiation dose preferably ranges between 1-300 mJ/m², preferably between 3-12 mJ/m². After the first radiation treatment a second radiation treatment, viz. full curing with long-wave UV or EB radiation, is preferably carried out.

It is in particular preferable if a press member having a structured surface is used during said pressing operation, which structured surface in particular abuts against the radiation-curable layer so as to thus transfer the structure of the pressure plate to the radiation-curable layer.

The present invention further relates to a decorative panel comprising a core provided with a decorative layer, which decorative layer comprises a radiation-curable component, characterised in that the degree of gloss is maximally 15, measured at an angle of 60° according to ASTM D523. It is in particular preferable if the degree of gloss changes by no more than 50%, tested according to EN438-2:2005, part 29.

It has been found to be possible, using the present method, to manufacture a decorative panel whose degree of gloss changes by maximally 10 units, measured at an angle of 60° and tested for 3000 hours according to EN438-2:2005, part 29.

The present invention in particular concerns the pre-matting of the radiation-curable layer, thereby giving the radiation-curable layer a so-called matted surface, after which the assembly of core and decorative layer is placed in a press, in which the decorative layer will plasticize to some extent as a result of the elevated temperature conditions therein, as a result of which the structure of the press member is “frozen” into the decorative layer without any stress relaxation taking place. A decorative panel manufactured in this way will exhibit a degree of gloss that will remain stable for a prolonged period of time.

The invention therefore relates to the use of a radiation treatment comprising a first radiation stage, using a wavelength in the 100-250 nm range, and a second radiation stage, using long-wave UV and/or electron beam (EB) radiation, so as to minimise the change in the degree of gloss in a decorative layer comprising radiation-curable components. Because of the special use of the present decorative panel in exterior environments, especially the degree of gloss, in particular the change therein, is an important and critical parameter.

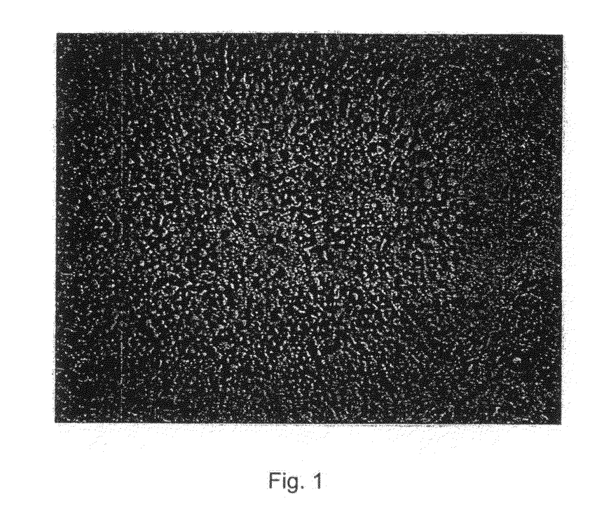

The present application will be explained hereinafter by means of a number of examples and associated FIGS. 1-4, in which connection it should be noted, however, that the present invention is by no means limited to such special examples.

FIGS. 1-4 show recordings of panel surfaces.

### COMPARATIVE EXAMPLE 1

A panel was used which consisted of a core of cellulose-containing fibre mats impregnated with phenol resol resin, which core was provided on either side thereof with a substrate layer consisting of a paper impregnated with phenol resol resin, which substrate layer was subsequently provided with a decorative layer comprising two pigmented or unpigmented radiation-curable (cured by means of EB radiation) layers, the outermost layer of the panel being a transparent layer consisting of transparent, acrylate-containing polyester urethane oligomers dissolved in 35% hexane diol diacrylate.

The above-described panel was compressed for a period of about 25 minutes at a temperature of about 165° C., using a pressure of 65 bar, so as to obtain a rigid panel. The aforesaid pressing operation was carried out by means of a press member, viz. a pressure plate having a coarse structure. After the pressing operation, the degree of gloss was 40 units, measured at an angle of 60°. The aforesaid value was indicated as glossy. After exposure of said panel to weather conditions for 67 hours, the degree of gloss increased by 10 to 20 units.

### COMPARATIVE EXAMPLE 2

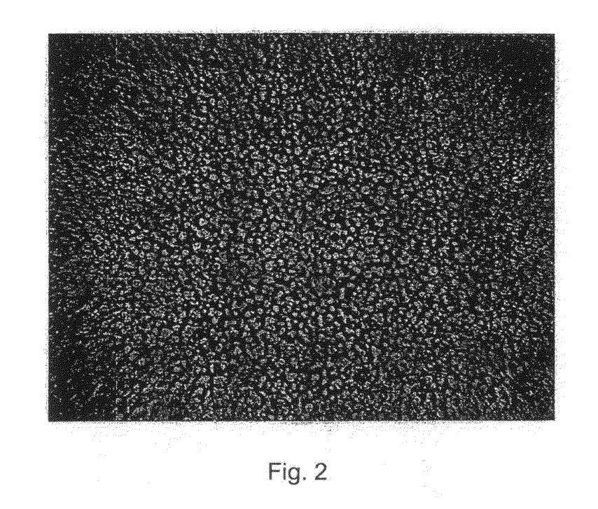

A panel similar to the panel described in Comparative Example 1 was compressed, but in this embodiment a pressure plate having a fine structure was used. After the pressure treatment, the degree of gloss was 20 units, measured at an angle of 60°. After exposure of said panel to the same weather conditions as in Comparative Example 1 for 67 hours, the degree of gloss increased by 30 to 40 units, measured at an angle of 60°. FIG. 1 shows a recording of the surface structure directly after the pressure treatment, whilst FIG. 2 shows a recording made after the surface had been exposed to weather conditions for 67 hours.

### EXAMPLE 3

### According to the Present Invention

A panel similar to the panel used in Comparative Example 1 was used, except that, prior to the pressure operation, the decorative layer was first subjected to a radiation treatment, using a wavelength of 172 nm, with the total radiation dose being 10 mJ/m². The entire decorative layer was then subjected to a second radiation treatment, using EB radiation. After the surface had thus been matted and subsequently post-cured, a pressing operation was carried out under the conditions mentioned in Comparative Example 1, using a pressure plate having a coarse structure, as in Comparative Example 1. After the pressing operation, the degree of gloss of the thus obtained panel was 8 units, measured at an angle of 60°. After exposure to the same weather conditions as mentioned in Comparative Example 1 and Comparative Example 2 for more than 330 hours, the degree of gloss decreased by 2 to 3 unis, measured at an angle of 60°.

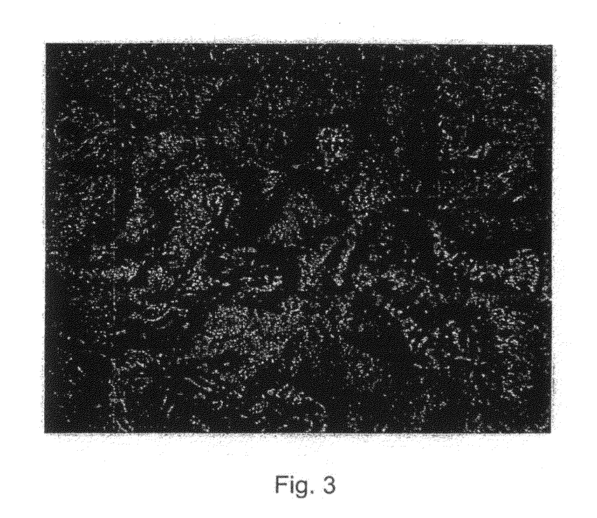

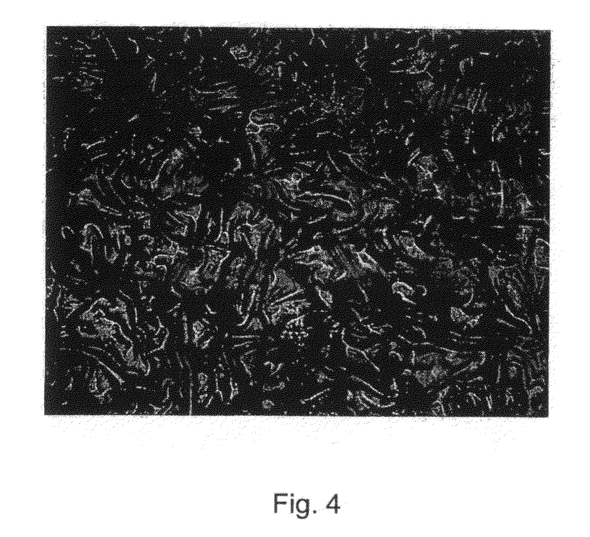

FIG. 3 shows a recording of the surface directly after the pressing operation, whilst FIG. 4 shows a recording of the same surface, in this embodiment after exposure to weather conditions for 330 hours, however. FIGS. 3 and 4 clearly show that the macrostructure of the press member that was used partially disappears and that the matting of the surface, obtained by matting the decorative layer through radiation, remains visible.

The weather conditions as mentioned before for each of the comparative examples and for the example according to the present invention were:
Light intensity: 0.55 W/m² at 340 nm, approx. 63 W/m² at 300-400 nm
Air temperature: 50° C.
Black panel
temperature: 75° C.
Cycle simulation: 120 minutes, of which 90 minutes light at an RH of 50±2%, followed by 30 minutes exposure and sprinkling.

### EXAMPLE 4

### Test for Exterior Use, Carried out According to EN438-2:2005, Part 29

| | | Gloss after | Gloss after | Gloss after | Gloss after |
|---|---|---|---|---|---|
| | | pressing, | 3000 hours of | pressing, | 3000 hours of |
| | | before testing | testing | before testing | testing |
| | | measured at | measured at | measured at | measured at |
| Experiment | Exposure | 60° | 60° | 85° | 85° |
| A | none | 14.4 | 27.4 | 21.9 | 34.5 |
| B | 172 nm, followed | 5.6 | 3.9 | 8.5 | 5.3 |
| | by EB | | | | |

### EXAMPLE 5

### Test for Exterior Use

Light intensity: 0.55 W/m² at 340 nm is approx. 63 W/m² at 300-400 nm
air temperature: 50° C.
Black panel
temperature: 75° C.
Cycle simulation: 120 minute cycle, of which 90 minutes light at an RH of 50+/−2%, followed by 30 minutes exposure and sprinkling.

| | | Gloss after | Gloss after | Gloss after | Gloss after |
|---|---|---|---|---|---|
| | | pressing, | 2000 hours of | pressing, | 2000 hours of |
| | | before testing | testing | before testing | testing |
| | | measured at | measured at | measured at | measured at |
| Experiment | Exposure | 60° | 60° | 85° | 85° |
| C | none | 14.4 | 27.9 | 21.9 | 36.2 |
| D | 172 nm, followed | 5.6 | 3.8 | 8.5 | 5.1 |
| | by EB | | | | |

### EXAMPLE 6

### Test for Interior Use

Lamps: UV-A 351 nm

Air temperature: 60+/−3° C.

Relative air humidity not controlled, depends on environment.

Normal test duration is discoloration from wool scale 6 to 5, this is 48 hours of testing.

| | | Gloss after | Gloss after | Gloss after | Gloss after |
|---|---|---|---|---|---|
| | | pressing, | 3000 hours of | pressing, | 66 hours of |
| | | before testing | testing | before testing | testing |
| | | measured at | measured at | measured at | measured at |
| Experiment | Exposure | 60° | 60° | 85° | 85° |
| E | none | 14.8 | 17.3 | 21.3 | 25.2 |
| F | 172 nm, followed | 6.7 | 6 | 10.4 | 9.3 |
| | by EB | | | | |

In examples 4-6 the panels A-F are similar to the panel described in Comparative Example 1.

1. A method for manufacturing a decorative panel for exterior use, comprising providing a core and a decorative layer, which decorative layer comprises radiation curable components, the core and the decorative layer are placed in a press and are pressed together therein under elevated temperature and pressure conditions so as to obtain the a decorative panel, which press is provided with a structured surface, which structured surface abuts against the decorative layer during the pressing operation, wherein before the pressing operation, the decorative layer is subjected to a radiation treatment comprising a first radiation stage, using a wavelength in the 100-250 nm range, and a second radiation stage, using long-wave UV and/or electron beam radiation, so as to minimize a change in the degree of gloss in the thus cured decorative layer.

2. The method according to claim 1, wherein a wavelength in the 170-180 nm range is used for the first radiation stage.

3. The method according to claim 2, wherein a wavelength of 172 nm is used for the first radiation stage.

4. The method according to claim 1 wherein a total radiation dose of 1-300 mJ/m² is used for the first radiation stage.

5. The method according to claim 4, wherein a total radiation dose of 3-12 m J/m² is used for the first radiation stage.

6. The method according to claim 1 wherein the decorative layer comprises an underlayer, which underlayer comprises paper, and which underlayer is present on the core comprising a stack of fiber-containing layers, wherein the underlayer and the decorative layer present thereon is supported on the fiber-containing layers during the pressing operation, such that the radiation cured decorative layer forms the outermost layer of the decorative panel.

7. The method according to claim 6, wherein the stack of fiber-containing layers compises a material selected from the group consisting of sodium kraft paper, a bound fabric and a densified fiber mat.

8. The method according to claim 7, wherein said bound fabric compises a material is selected from the group consisting of wood and cellulose fibres.

9. The method according to claim 1 wherein the pressing operation is carried out at a temperature of about 80-220° C. and a pressure of about 5-100 bar.

10. The method according to claim 9, wherein the temperature ranges between 120 and 220° C. and the pressure ranges between 10 and 100 bar.

11. The method according to claim 1 wherein the decorative layer comprises maximally 5%, solid particles, based on the weight of the cured decorative layer.

12. A decorative panel comprising a core provided with a decorative layer, which decorative layer comprises a radiation-curable component, wherein the decorative panel has a degree of gloss which is maximally 15, measured at an angle of 60° according to ASTM D523.

13. The decorative panel according to claim 12, wherein the degree of gloss of the decorative panel changes by maximally 10 units, measured at an angle of 60° and tested for 3000 hours according to EN438-2:2005, part 29.

14. The decorative panel according to claim 12, wherein the degree of gloss changes by no more than 50%, tested according to EN438-2:2005, part 29.

15. (canceled)

16. The method according to claim 2 wherein a total radiation dose of 1-300 mJ/m² is used for the first radiation stage.

17. The method according to claim 3 wherein a total radiation dose of 1-300 mJ/m² is used for the first radiation stage.

18. The method according to claim 16, wherein a total radiation dose of 3-12 mJ/m² is used for the first radiation stage.

19. The method according to claim 17, wherein a total radiation dose of 3-12 mJ/m² is used for the first radiation stage.

20. The method according to claim 2 wherein the decorative layer comprises an underlayer, which underlayer comprises paper, and which underlayer is present on the core comprising a stack of fiber-containing layers, wherein the underlayer and the decorative layer present thereon is supported on the fiber-containing layers during the pressing operation, such that the radiation cured decorative layer forms the outermost layer of the decorative panel.

21. The method according to claim 3 wherein the decorative layer comprises an underlayer, which underlayer comprises paper, and which underlayer is present on the core comprising a stack of fiber-containing layers, wherein the underlayer and the decorative layer present thereon is supported on the fiber-containing layers during the pressing operation, such that the radiation cured decorative layer forms the outermost layer of the decorative panel.
